(19) United States
(12) Patent Application Publication
(10) Pub. No.: US 2024/0072991 A1
(43) Pub. Date: Feb. 29, 2024

(54) SYSTEM AND METHOD INCORPORATING MODULAR DATA ENCRYPTION FOR AN ELECTRONIC DEVICE

(71) Applicant: Palo Alto Research Center Incorporated, Palo Alto, CA (US)

(72) Inventors: Francisco E. TORRES, San Jose, CA (US); Eric D. COCKER, Redwood City, CA (US)

(73) Assignee: Palo Alto Research Center Incorporated, Palo Alto, CA (US)

(21) Appl. No.: 17/898,826

(22) Filed: Aug. 30, 2022

(51) Int. Cl. H04L 9/00; G01S 19/16

(52) U.S. Cl. CPC H04L 9/008; G01S 19/16; H04L 2209/805

(57) ABSTRACT

A system and method are provided wherein encrypted data is stored in modular lockers on a first storage volume associated with a high-power microprocessor deployed in a system. Each encrypted locker maps, for example, to a specific time segment (e.g., one day) which simplifies mounting of the encrypted volume for data access and reduces the locker size for external access of data while encrypted (e.g., via Wifi). New data in a second storage volume associated with and generated by a low-power microprocessor associated with the system gets transferred to the encrypted data store during wake cycles of the high-power microprocessor. To manage space on the first storage volume, time stamps associated with each encrypted locker allows simple removal of files older than a specified time period by removing of any encrypted lockers older than that threshold.

### STATEMENT REGARDING FEDERALLY SPONSORED RESEARCH OR DEVELOPMENT

This invention was made with United States Government support under Contract No. HR00112090101 awarded by DARPA. The United States Government has certain rights in the invention.

### TECHNICAL FIELD

The present specification relates to data management and/or processing. In one example, it relates to data management and/or processing for floating sensors (or sensor carrying devices or floats) deployed on the open sea. Thus, it finds suitable application in connection with, for example, oceanic sensors and will be described with particular reference thereto. However, it is to be appreciated that the subject matter described herein is equally suited to and/or adapted for other like applications.

### BACKGROUND

It has been proposed to deploy inexpensive devices floating on the ocean to detect and report a variety of signals, including images, environmental information and signals generated by human activity and radio communications. For example, one proposed initiative aims to deploy a large fleet of inexpensive floating sensors (referred to herein as floats) that include a variety of different sensors and cameras. One example of such a deployment is referred to as the Ocean of Things (OoT).

As proposed, the collected data, including image data collected by the float's camera, is communicated from the float to a desired remote location (i.e., remote relative to the float) via a radio communication and/or wireless telecommunication link, e.g., a wireless link and/or radio communication to a satellite in orbit about the earth. The transmission of this data is generally permitted to employ and/or occupy a limited amount of time, bandwidth and/or other resources of the satellite and/or wireless link over which the transmission is being placed.

In some cases, these devices or floats may be restricted to selectively transmit acquired data with extremely limited data rates (e.g., 340 Bytes/20 minutes); in such cases, it is generally important to transmit only essential information that is relevant to a particular goal or objective. Under such restrictive constraints, it may be infeasible and/or undesirable to rely on traditional data processing and/or storage techniques for operation of these devices.

### BRIEF DESCRIPTION

According to one aspect of the presently described embodiments, a system comprises sensor devices configured to collect sensor data, a first data storage element, a second data storage element, a first processor and a first memory having code or instructions stored thereon that, when executed by the first processor, cause the first processor to collect first sensor data and store the first sensor data on the first data storage element, and a second processor and a second memory having stored thereon code or instructions that, when executed by the second processor, cause the second processor to collect and process second sensor data, periodically retrieve the first sensor data from the first data storage element, encrypt the first and second sensor data, and store the encrypted sensor data in the second data storage element in individually accessible storage modules arranged according to a time period when the sensor data was collected or generated, or data type.

In another aspect of the presently described embodiments, the first processor is further caused to retrieve encrypted sensor data from selected storage modules of the second data storage element in response to, and for transmission to, an interrogation device.

In another aspect of the presently described embodiments, the second processor is further caused to trigger transmission of encrypted sensor data from the second data storage element to a satellite.

In another aspect of the presently described embodiments, the system is incorporated on a float device.

In another aspect of the presently described embodiments, the storage modules are deleted when determined to be no longer relevant based on information associated with the storage module.

In another aspect of the presently described embodiments, the information associated with the storage module is acquisition date.

In another aspect of the presently described embodiments, the symbolic links to files stored in the storage modules are maintained to provide a catalog of available files to subcomponents of the system.

In another aspect of the presently described embodiments, the symbolic links are maintained in a flash storage of a device accessing the storage modules.

In another aspect of the presently described embodiments, a method to be implemented on a system having sensor devices configured to collect sensor data, a first data storage element, a second data storage element, a first processor and a second processor, comprises collecting, by the first processor, first sensor data, storing, by the first processor, the first sensor data on the first data storage element, collecting and processing, by the second processor, second sensor data, periodically retrieving, by the second processor, the first sensor data from the first data storage element, encrypting, by the second processor, the first and second sensor data and storing, by the second processor, the encrypted sensor data in the second data storage element in individually accessible storage modules arranged according to a time period when the sensor data was collected or generated, or data type.

In another aspect of the presently described embodiments, the method further comprises retrieving, by the first processor, encrypted sensor data from selected storage modules of the second data storage element in response to, and for transmission to, an interrogation device.

In another aspect of the presently described embodiments, the method further comprises transmitting, triggered by the second processor, encrypted sensor data from the second data storage element to a satellite.

In another aspect of the presently described embodiments, the system is incorporated on a float device.

In another aspect of the presently described embodiments, the storage modules are deleted when determined to be no longer relevant based on information associated with the storage module.

In another aspect of the presently described embodiments, the information associated with the storage module is acquisition date.

In another aspect of the presently described embodiments, the symbolic links to files stored in the storage modules are maintained to provide a catalog of available files to subcomponents of the system.

In another aspect of the presently described embodiments, the symbolic links are maintained in a flash storage of a device accessing the storage modules.

### BRIEF DESCRIPTION OF THE DRAWINGS

FIG. 1 is an example system into which the presently described embodiments may be incorporated.

FIG. 2 illustrates an example modular data encryption scheme according to the presently described embodiments.

FIG. 3 illustrates an example method according to the presently described embodiments.

FIG. 4 illustrates an example method according to the presently described embodiments.

FIG. 5 illustrates an example method according to the presently described embodiments.

### DETAILED DESCRIPTION

According to the presently described embodiments, a system or method is provided where data or information is secured in modular storage volumes or “lockers”, e.g., modular data encryption. Each locker is encrypted and individually accessible within the encompassing storage volume. Data or information is segregated into storage lockers based on a time period when the data or information was collected or generated. In addition or alternately, data or information is segregated into storage lockers based on the type of data or information. Data storage, management and processing according to the presently described embodiments, especially in the example of devices or floats deployed in the OoT, allow for improved performance in the contemplated environments.

For example, the presently described embodiments using the technique of modular data encryption are an improvement over an approach of encrypting the entire storage volume of stored data. For such an approach of encrypting the entire volume in the present example of devices or floats deployed in the OoT, either the low power microprocessor typically aboard the float would need to support storage volume encryption (which it does not), or the high-compute single board computer (SBC) (or high-compute microprocessor) typically aboard the float would need to decrypt and transfer data to the low power microprocessor through another or a dedicated communication channel (and such a channel is too energy intensive for this example application).

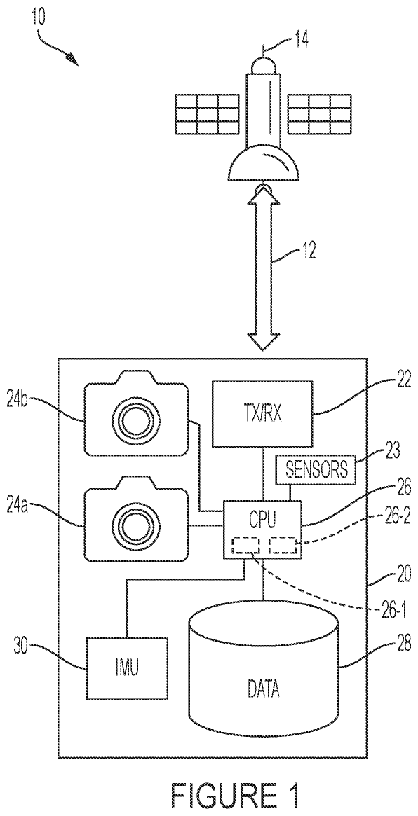

With reference to FIG. 1, there is illustrated an exemplary embodiment of a system 10 including a sensor carrying device 20. In practice, the sensor carrying device 20 is equipped and/or otherwise provisioned with a transceiver 22. Via the transceiver 22, the sensor carrying device 20 wirelessly communicates (i.e., transmits and/or receives messages, signals and/or data) over a wireless telecommunications link 12. As shown, the link 12 operatively, wirelessly connects the sensor carrying device 20 to a satellite 14 in orbit about the Earth or other planet on which the sensor carrying device 20 is situated. In practice, the satellite 14 operates to relay messages, data and/or signals between the sensor carrying device 20 and an end user device, e.g., such as a computer, server or the like located remotely away from the sensor carrying device 20, which end user device receives data originating from the sensor carrying device 20 and/or administers operation thereof. A variety of sensors, at least some of which are mentioned herein but not specifically shown, may be implemented on the device 20 and are generally represented by the element 23 in FIG. 1.

As shown, the sensor carrying device or float 20 is equipped and/or otherwise provisioned with at least one camera, but in this example case, two (2) cameras 24a and 24b, e.g., digital cameras, that selectively captures images of the environment in which the sensor carrying device 20 is placed. Although two (2) cameras are shown, any number of cameras (e.g. 1, 2, 3, 4, . . . ) could be used depending on the implementation. Also, it should be appreciated that a float equipped with one or more cameras is merely an example configuration. Other sensor configurations, including configurations without a camera or cameras, may be implemented. It should be appreciated that the camera(s) (if cameras are implemented) (only representatively shown for ease of illustration) will be suitably positioned on the float to achieve the objective of the implementation, e.g., to achieve suitable views in expected orientations to capture desired imaging. Suitably, the sensor carrying device or float 20 is made to be sufficiently buoyant to float on the surface of a body of water, e.g., such as an ocean, sea, lake, etc. In practice, the sensor carrying device or float 20 may be implemented as or on a buoy or the like and will be, on occasion, referred to herein as a float. It should be appreciated, however, that the presently described embodiments are most advantageously implemented in environments where small, lower-power multi-sensory floats are utilized. However, the presently described embodiments will nonetheless have advantages if implemented on traditional buoys with less power limitations.

Further, the sensor carrying device or float 20 includes an Inertial Measurement Unit (IMU) 30. The IMU 30 measures change in the pose or position of the sensor carrying device or float 20. The IMU 30 may also measure the velocity and other operational characteristics of the sensor carrying device or float 20. Such devices are well known and operate to measure and output forces, angular rates and orientation of an object. Typically, IMUs use accelerometers, gyroscopes and/or magnetometers to gather data. Here, a variety of configurations could be utilized, but in at least on form of the presently described embodiments, the IMU 30 operates in appropriate ways to utilize suitable sensors to measure and output data on, for example, pitch, roll and yaw, as well as other positional, orientational or operational data related to the sensor carrying device or float 20.

In a suitable embodiment, the sensor carrying device or float 20 is equipped and/or otherwise provisioned with a central processing unit (CPU) and/or data processor 26 and a data storage device 28. Of course, it should be appreciated that the processor 26 is provided with suitable non-transitory memory structures (not shown unless data storage 28 is used of such purposes) such as a memory or memories having stored therein code, instructions or routines that can be executed by the processor to perform functions or trigger or enable other components to perform functions. In practice, the data processor 26 controls operation of the sensor carrying device or float 20 and/or regulates operation of the various components thereof. Measurements and/or data collected, generated and/or produced by the sensors (e.g., cameras and IMU sensors) carried on the sensor carrying device or float 20, including IMU data on the pose and velocity of the sensor carrying device or float 20 generated, produced and/or output by the IMU 30 and image data generated, produced and/or output by, for example, the cameras 24a and 24b as a result of image(s) being captured thereby, are suitably stored by and/or maintained in the data storage device 28.

Additionally, the data processor 26 suitably performs image and/or other data processing on the data including image data (where applicable) as described herein. The results of such image and/or other data processing performed on the data may likewise be stored by and/or maintained in the data storage device 28. Suitably, the data storage device 28 may also store and/or maintain instructions, software, program code and/or the like which is executed by the data processor 26 to carry out the function(s) thereof and/or operation(s) performed thereby.

Further, the data processor 26 may be configured in a variety of different manners including as a system comprising multiple dedicated processor elements to perform specific functions or groups of functions. For example, in one form, more than one processor or processor element is provided. A first processor or processor element 26-1 tracks data constantly, or tracks data using dense reading techniques, for example, every two (2) to four (4) minutes. In at least one form, this processor element 26-1 operates in a low-power mode. In at least one form, it conducts less sophisticated processing (e.g., signal processing from the sensors) than the second processor. The types of tracked data from suitable on-board sensors may include, for example, atmospheric data, water data (e.g., salinity) or volatile organic compounds (voc) sensor data (related to, for example, plankton in the water). The first processor element, in one form, also controls and tracks the data generated by the IMU 30.

A second processor or processor element 26-2 may be provided that is triggered or engaged (or “wakes up”) periodically, e.g., approximately every twenty (20) minutes. In one form, this second processor element is a higher power or high compute processor or processor element than the first processor or processor element. In at least one form, it conducts more sophisticated processing (e.g., image processing, anomaly determination, data analysis, . . . etc.) than the first processor). When it wakes up, the second processor element performs suitable functions of data processing and management and may also trigger select sensors to perform, such as trigger the camera or cameras (if cameras are implemented) to capture and process images at an appropriate time, and then transfer processed and/or stored data, including the captured images, via satellite or cloud-based system. The second processor element also has access to the IMU 30 for purpose of, for example, determining the appropriate moment to capture an image. Notably, the second processor 26-2 supports and uses encryption techniques for storing data according to the presently described embodiments.

As alluded to above, it will be appreciated that the processor 26 and/or processor elements 26-1 and 26-2 (and any other processing devices implemented) will, in at least one form, use any of a variety of different memory devices (not shown except that such devices may be represented by or incorporated in memory device 28 in some examples). Such devices, for example, will take the form of non-transitory computer or machine-readable mediums having code or instruction, stored thereon, for execution by the appropriate processors to enable or cause the system to perform or function as described.

In practice, stored and/or processed data is wirelessly transmitted via the transceiver 22 from the sensor carrying device 20 over the link 12, e.g., to the satellite 14 which in turn relays the processed image data to the end user device. Suitably, the transmitted data is relayed to the end user device from the satellite 14 over a suitable telecommunications network with which the satellite 14 is in operative communication.

In practice, due to the limited resources of the satellite 14, traffic constraints on the link 12 and/or otherwise, a significantly limited bandwidth and/or data rate is established and/or imposed for the transmission of data, including image data, from the sensor carrying device 20 over the link 12. For example, the aforementioned bandwidth and/or data rate may be limited to around no more than 340 bytes per 20 minutes. Accordingly, the image and/or other data processing performed by the sensor carrying device 20 (e.g., via the data processor 26) generates and/or produces processed data such as image data which is suitably compressed to fit within a designated size, e.g., within a set limit and/or determined number of bytes or bits. In this way, the processed data can be efficiently transmitted from the sensor carrying device 20 (e.g., via the transceiver 22) over the link 12 within the allotted bandwidth and/or at the imposed data rate while maintaining a suitable amount of desired information from the corresponding data such as image data captured by the camera 24.

In connection with an example implementation according to the presently described embodiments, on floats deployed in the Ocean of Things (OoT) environment, each compute resource (i.e., a low power microprocessor or first processor 26-1 and a high-compute single board computer (SBC) or second processor 26-2) has a dedicated storage volume in order to prevent data corruption. Each compute resource has read access to both storage volumes while write access is restricted to the respective dedicated storage volumes. Restricting write access in this way prevents data corruption that could otherwise occur if two compute resources are using different operating and/or file systems. For some applications, certain types of data need to be stored in encrypted format but only the second processor 26-2, or SBC, supports encryption capability. Additionally, the low-power microprocessor or first processor 26-1 needs to be able to read relatively small chunks of data in order to transmit them over Wifi during a data pull from a float. In edge applications, it can be advantageous to use multiple compute resources that may not create or manipulate files in a 100% compatible way. Read access by one compute resource of a file created by another compute resource can usually be done without causing corruption if the file systems used are nominally compatible, but even slight differences in file system assumptions and configurations can lead to corruption when multiple compute resources create or manipulate files on the same volume/partition.

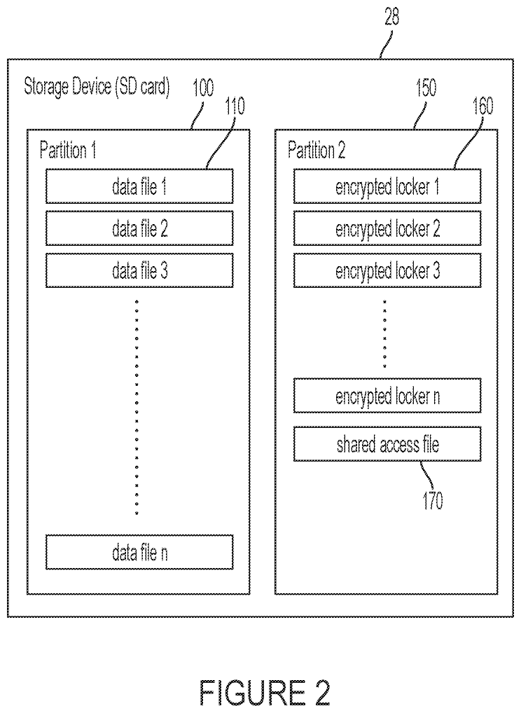

As such, according to the presently described embodiments, the data storage device 28 may take a variety of forms to achieve the objections of the presently described embodiments. However, one example and/or representative form is illustrated in FIG. 2. As shown, the data storage device 28 comprises a first portion or data storage element, or partition, 100, and a second portion or data storage element, or partition, 150. The first partition 100 includes data files 110 and the second partition 150 includes data files stored in, for example, lockers or storage modules 160, as well as a shared access file 170. The lockers or storage module 160 may take a variety of forms and have varying metrics depending on the application. However, in at least one form, the lockers or storage modules 160 are of a predefined size or dimension corresponding an expected amount of data to be collected or generated during a time period, e.g., during one day. In one example, each locker or storage module is 200 megabytes. Also, it should be appreciated that the size of the lockers or storage modules may, in suitable circumstances, be implemented to be configurable. The shared access file 170 may take a variety of forms including, for example, a single file or multiple files (e.g., any number of files that are left unencrypted so that the processor without decryption capability can read them without assistance). It should be appreciated that each compute resource (e.g., data processor element 26-1 and data processor element 26-2) has a dedicated storage partition. The first data storage element 100, or Partition 1, is dedicated to low-power microprocessor (i.e., data processor element 26-1). The second data storage element 150, or Partition 2, is dedicated to high-compute SBC (i.e., data processor element 26-2). This is done so the edge microprocessors can run different operating and file systems, to optimize and address limitations of edge resources. Each compute resource needs read access to both storage volumes but only write access to dedicated storage volume. Certain types of data need to be stored encrypted. Again, only the second processor element 26-2, or SBC, supports a file system with encryption capability. Thus, the second data storage element includes the encrypted storage modules or lockers.

According to the presently described embodiments, encrypted data stored is in modular lockers on the second storage element, or SBC storage volume. Each encrypted locker 160 maps to a specific time segment (e.g., 1 day). It simplifies mounting of encrypted volume for data access and reduces locker size for external access of data while encrypted (e.g., via Wifi connection through low-power microprocessor). New data generated by the data collection of the low power microprocessor or first processor 26-1 is initially stored in the first data storage element 100, or Partition 1, gets periodically transferred to the second data storage element, or Partition 2, and encrypted by the second processor, for example, during each SBC wake cycle.

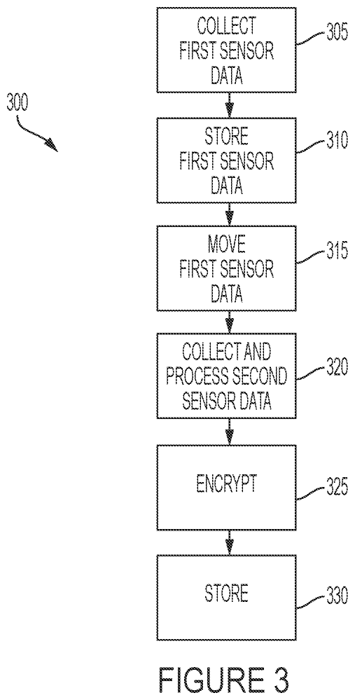

Thus, in operation, with reference now to FIG. 3, an example method for the presently described embodiments will be explained for an example system having sensor devices configured to collect sensor data, a first data storage element (such as first data storage element 100 of data storage device 28), a second data storage element (such as second data storage element 150 of data storage device 28), a first processor (such as first processor or processor element 26-1) and a second processor (or second processor or processor element 26-2). As shown, a method 300 comprises collecting, by the first processor, first sensor data (at 305). Then, the first processor stores the first sensor data on the first data storage element (at 310). Periodically, such as at every wake cycle of the second processor, the first sensor data is moved from the first data storage element (at 315). In this regard, in at least one form, the second processor looks in the first data storage element for any new data of a certain type that requires encryption and copies it over to the second data storage element. After copying a file, the SBC or second processor then notifies the first processor that the version of the file on the first data storage element can be deleted (e.g. by using a shared access file on the second data storage element). Other types of transfer of the first sensor data may also be implemented. During wake cycles, the second processor collects and processes second sensor data (at 320). The second processor then encrypts the first and second sensor data (at 325). The encrypted sensor data is then stored in the second data storage element in individually accessible data modules arranged according to a time period when the sensor data was collected or generated, or data type (at 330).

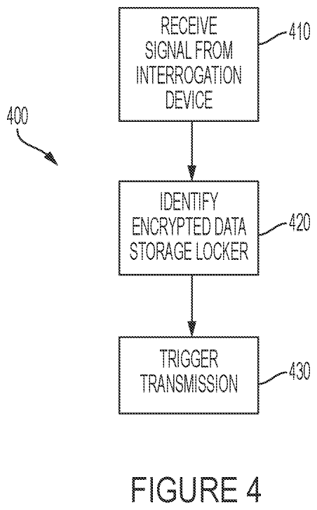

The presently described embodiments provide several advantageous and improved processes for the system, especially the example system of devices or floats used in the OoT environment. For example, the system allows the first processor to conveniently retrieve encrypted sensor data from selected storage modules of the second data storage element in response to, and for transmission to, an interrogation device. Without implementation of the modular data encryption techniques of the presently described embodiments, interrogation of float devices was limited because the first processor was not capable of transmitting high volumes of encrypted data during interrogation or it would take a prohibitively long period of time. In this regard, with reference to FIG. 4, a method 400 includes receiving (through suitable TX/RX devices), by the first processor, a signal from an interrogation device (at 410). The first processor then identifies an encrypted data storage locker on the second data storage element for transmission to the interrogation device (at 420). Then, the first processor triggers the transmission (at 430).

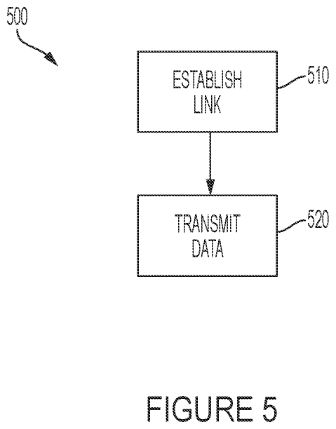

Likewise, during normal operation of the system, the presently described embodiments provide improved processes. For example, the second processor is further caused to trigger transmission of encrypted sensor data from the second data storage element to a satellite. Because the encrypted data is stored in a more manageable size and convenient format using the contemplated lockers or modules arranged by retrieval time or data type, data management and processing issues are minimized. Accordingly, for example, when it is determined useful to access historical data to be used in the analysis of recently collected data, having the ability to decrypt only the locker or lockers containing the most recent time period of data greatly reduces the associated processing (and thus energy) overhead. With reference to FIG. 5, a method 500 includes establishing a link with, for example, a satellite by the second processor (at 510). Once the link is established, the second processer then triggers transmission of encrypted data in units of storage (e.g., the modules or lockers) including, if desired or determined, historical data to be used in the analysis of recently collected data that is stored in a locker or lockers according to recent time periods, e.g., the more recent time periods (at 520).

In addition, in one form, a storage volume space management service or the like (e.g., a routine run by one of the on-board processors or an off-board device) can use information associated with a storage locker, e.g., acquisition date, to automatically remove storage lockers that are no longer relevant in order to free storage space. In another form, symbolic links to the files stored in each storage locker are maintained within memory of the device accessing the storage volume in order to provide a catalogue of available files to subcomponents of the system. In still another form, symbolic links to the files stored in each storage locker are maintained within flash storage of the device accessing the storage volume in order to provide a catalogue of available files to subcomponents of the system.

As an alternative or supplemental approach, instead of being grouped by time period, data could be separated by type (or both type and time period) in order to provide further granularization for data access.

It should also be appreciated that, as a further alternative to the presently described embodiments, a similar function could be obtained by encrypting each file individually. This method, though, creates significant and undesired overhead during internal data access requests (e.g., each file needs to be decrypted/encrypted individually) and reduces security provided by encryption by potentially leaving information on the type and amount of data visible via file names and file meta data.

The above methods, system, platforms, modules, processes, algorithms and/or apparatus have been described with respect to particular embodiments. It is to be appreciated, however, that modifications and/or alteration are also contemplated. For example, the function of transmitting may be modified, eliminated or delayed in certain implementations.

For clarity and simplicity, the present specification refers to structural and/or functional elements, relevant standards, algorithms and/or protocols, and other components, methods and/or processes that are commonly known in the art without further detailed explanation as to their configuration or operation except to the extent they have been modified or altered in accordance with and/or to accommodate the preferred and/or other embodiment(s) presented herein. Moreover, the apparatuses and methods disclosed in the present specification are described in detail by way of examples and with reference to the Figures. Unless otherwise specified, like numbers in the Figures indicate references to the same, similar or corresponding elements throughout the Figures. It will be appreciated that modifications to disclosed and described examples, arrangements, configurations, components, elements, apparatuses, methods, materials, etc. can be made and may be desired for a specific application. In this disclosure, any identification of specific materials, techniques, arrangements, etc. are either related to a specific example presented or are merely a general description of such a material, technique, arrangement, etc. Identifications of specific details or examples are not intended to be, and should not be, construed as mandatory or limiting unless specifically designated as such. Selected examples of apparatuses and methods are hereinafter disclosed and described in detail with reference made to the Figures.

It is to be appreciated that in connection with the particular exemplary embodiment(s) presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that any one or more of the particular tasks, steps, processes, methods, functions, elements and/or components described herein may suitably be implemented via hardware, software, firmware or a combination thereof. In particular, various modules, components and/or elements may be embodied by processors, electrical circuits, computers and/or other electronic data processing devices that are configured and/or otherwise provisioned to perform one or more of the tasks, steps, processes, methods and/or functions described herein. For example, a processor, computer or other electronic data processing device embodying a particular element may be provided, supplied and/or programmed with a suitable listing of code (e.g., such as source code, interpretive code, object code, directly executable code, and so forth) or other like instructions or software or firmware, such that when run and/or executed by the computer or other electronic data processing device one or more of the tasks, steps, processes, methods and/or functions described herein are completed or otherwise performed. Suitably, the listing of code or other like instructions or software or firmware is implemented as and/or recorded, stored, contained or included in and/or on a non-transitory computer and/or machine-readable storage medium or media so as to be providable to and/or executable by the computer or other electronic data processing device. For example, suitable storage mediums and/or media can include but are not limited to: floppy disks, flexible disks, hard disks, magnetic tape, or any other magnetic storage medium or media, CD-ROM, DVD, optical disks, or any other optical medium or media, a RAM, a ROM, a PROM, an EPROM, a FLASH-EPROM, or other memory or chip or cartridge, or any other tangible medium or media from which a computer or machine or electronic data processing device can read and use. In essence, as used herein, non-transitory computer-readable and/or machine-readable mediums and/or media comprise all computer-readable and/or machine-readable mediums and/or media except for a transitory, propagating signal.

Optionally, any one or more of the particular tasks, steps, processes, methods, functions, elements and/or components described herein may be implemented on and/or embodiment in one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the respective tasks, steps, processes, methods and/or functions described herein can be used.

Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to exemplary embodiments. Obviously, modifications and alterations will occur to others upon reading and understanding the present specification. It is intended that all such modifications and alterations are included herein insofar as they come within the scope of the appended claims or the equivalents thereof. It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A system comprising:
sensor devices configured to collect sensor data;
a first data storage element;
a second data storage element;
a first processor and a first memory having code or instructions stored thereon that, when executed by the first processor, cause the first processor to collect first sensor data, and store the first sensor data on the first data storage element; and,
a second processor and a second memory having stored thereon code or instructions that, when executed by the second processor, cause the second processor to collect and process second sensor data, periodically retrieve the first sensor data from the first data storage element, encrypt the first and second sensor data, and store the encrypted sensor data in the second data storage element in individually accessible storage modules arranged according to a time period when the sensor data was collected or generated, or data type.

2. The system as set forth in claim 1, wherein the first processor is further caused to retrieve encrypted sensor data from selected storage modules of the second data storage element in response to, and for transmission to, an interrogation device.

3. The system as set forth in claim 1, wherein the second processor is further caused to trigger transmission of encrypted sensor data from the second data storage element to a satellite.

4. The system as set forth in claim 1, wherein the system is incorporated on a float device.

5. The system as set forth in claim 1, wherein the storage modules are deleted when determined to be no longer relevant based on information associated with the storage module.

6. The system as set forth in claim 5, wherein the information associated with the storage module is acquisition date.

7. The system as set forth in claim 1, wherein symbolic links to files stored in the storage modules are maintained to provide a catalog of available files to subcomponents of the system.

8. The system as set forth in claim 7, wherein the symbolic links are maintained in a flash storage of a device accessing the storage modules.

9. A method to be implemented on a system having sensor devices configured to collect sensor data, a first data storage element, a second data storage element, a first processor and a second processor, the method comprising:
collecting, by the first processor, first sensor data;
storing, by the first processor, the first sensor data on the first data storage element;
collecting and processing, by the second processor, second sensor data;
periodically retrieving, by the second processor, the first sensor data from the first data storage element;
encrypting, by the second processor, the first and second sensor data; and,
storing, by the second processor, the encrypted sensor data in the second data storage element in individually accessible storage modules arranged according to a time period when the sensor data was collected or generated, or data type.

10. The method as set forth in claim 9, further comprising retrieving, by the first processor, encrypted sensor data from selected storage modules of the second data storage element in response to, and for transmission to, an interrogation device.

11. The method as set forth in claim 9, further comprising transmitting, triggered by the second processor, encrypted sensor data from the second data storage element to a satellite.

12. The method as set forth in claim 9, wherein the system is incorporated on a float device.

13. The method as set forth in claim 9, wherein the storage modules are deleted when determined to be no longer relevant based on information associated with the storage module.

14. The method as set forth in claim 13, wherein the information associated with the storage module is acquisition date.

15. The method as set forth in claim 9, wherein symbolic links to files stored in the storage modules are maintained to provide a catalog of available files to subcomponents of the system.

16. The method as set forth in claim 15, wherein the symbolic links are maintained in a flash storage of a device accessing the storage modules.
